(19) United States
(12) Patent Application Publication
(10) Pub. No.: US 2025/0281342 A1
(43) Pub. Date: Sep. 11, 2025

(54) DETECTION OF ACTUATOR QUICK RELEASE ACTIVATION

(71) Applicant: Hill-Rom Services, Inc., Batesville, IN (US)

(72) Inventors: Jacques Antoine Donval, Pluvigner (FR); Sebastien Jean Henri Cou, Erdeven (FR); David Jean Francois Guyot, Landaul (FR); Thomas Morel, Auray (FR)

(73) Assignee: Hill-Rom Services, Inc., Batesville, IN (US)

(21) Appl. No.: 19/062,239

(22) Filed: Feb. 25, 2025

Related U.S. Application Data
(60) Provisional application No. 63/563,561, filed on Mar. 11, 2024.

(51) Int. Cl. A61G 13/10; A61G 13/04; A61G 13/12; A61H 31/00

(52) U.S. Cl. CPC A61G 13/105; A61G 13/04; A61G 13/1265; A61G 13/1285; A61H 31/008; A61G 2203/30

(57) ABSTRACT

A quick release system for a patient support apparatus includes an arm that moves a cable to release an actuator so that a frame of the patient support apparatus moves to a CPR position. A detector detects a position of the arm.

### CROSS-REFERENCE TO RELATED APPLICATIONS

This application claims priority under 35 U.S.C. § 119 (e) to U.S. Provisional Patent Application Ser. No. 63/563,561, filed Mar. 11, 2024, which is expressly incorporated by reference herein.

### BACKGROUND

The present disclosure relates to an actuator quick release and, in particular, to detection of an actuator quick release.

Hospital beds typically include a CRP handle that is activated to move the support sections of the bed into flat positions that are level to the ground. When the CPR handle is activated, a quick release system having a cable connected to a clutch of the CPR handle releases at least one actuator responsible for positioning the various support sections of the bed. Upon release of the actuator, the support sections return to the flat configuration.

Generally, to detect the activation of the quick release system of an actuator, access to the clutch is achieved by drilling into a cover of the system and a mechanical detection device with a pin and a mechanical switch is inserted at the clutch. This solution potentially leads to a loss of the systems IP rating, which is a measure of the resistance of the system to dust or liquids. This can lead to mechanical blocking in the system due to dust insertion. Such complex mechanical adjustments to the parts can also degrade the actuator functions.

### SUMMARY

The present disclosure includes one or more of the features recited in the appended claims and/or the following features which, alone or in any combination, may comprise patentable subject matter.

According to a first aspect of the disclosed embodiments, a patient support apparatus includes a frame having an actuator that moves the frame to various positions. A handle is moveable between a deactivated position and an activated position. In the activated position, the handle releases the actuator of the frame to move the frame to a CPR position. An arm is coupled to the handle and moveable with the handle. In the activated position, the arm releases the actuator. A magnet is coupled to the arm. A magnetic field detector detects the magnet when the handle is in the deactivated position. The magnetic field detector does not detect the magnet when the handle is in the activated position.

In some embodiments of the first aspect a housing may be provided. The arm and the magnet may be positioned inside the housing. The magnetic field detector may be positioned outside the housing. The magnet may generate a magnetic field that is detectable by the magnetic field detector. The magnetic field detector may transmit an electrical current in the presence of the magnetic field. A controller may be provided. When the handle is in the deactivated position, the controller may receive the electrical current. When the handle is in the activated position, the controller may not receive the electrical current. A user interface may indicate to a user whether the handle is in the activated position or the deactivated position based on whether the controller receives the electrical current. The user interface may be at least one of a mobile device and a remote device.

Optionally, in the first aspect, the arm may rotate about an axel. The magnet may be positioned on an end of the arm so that the magnet rotates about the axel. A cable may attach the arm to the handle.

It may be desired, in the first aspect, that, in response to the handle being moved to the activated position, at least one motor may move the frame to lie substantially parallel to the ground. In response to the handle being moved to the activated position, the frame may be moved into a Trendelenburg position. In response to the handle being moved to the activated position, a mattress positioned on the frame may be deflated. In response to the handle being moved to the activated position, a mattress positioned on the frame may be inflated.

According to a second aspect of the disclosed embodiments, a quick release system for a patient support apparatus includes an arm that is moveable between a deactivated position and an activated position. In the activated position, the arm releases an actuator so that a frame of the patient support apparatus moves to a CPR position. A magnet is coupled to the arm. A magnetic field detector detects the magnet when the arm is in the deactivated position. The magnetic field detector does not detect the magnet when the arm is in the activated position.

In some embodiments of the second aspect a housing may be provided. The arm and the magnet may be positioned inside the housing. The magnetic field detector may be positioned outside the housing. The magnet may generate a magnetic field that is detectable by the magnetic field detector. The magnetic field detector may transmit an electrical current in the presence of the magnetic field. A controller may be provided. When the arm is in the deactivated position, the controller may receive the electrical current. When the arm is in the activated position, the controller may not receive the electrical current. A user interface may indicate to a user whether the arm is in the activated position or the deactivated position based on whether the controller receives the electrical current. The user interface may be at least one of a mobile device and a remote device.

Optionally, in the second aspect, the arm may rotate about an axel. The magnet may be positioned on an end of the arm so that the magnet rotates about the axel. The axel may couple to the actuator.

According to a third aspect of the disclosed embodiments, a quick release system for a patient support apparatus includes a housing coupled to the patient support apparatus. An arm is positioned in the housing. The arm is moveable about an axel between a deactivated position and an activated position. In the activated position, the arm releases a frame of the patient support apparatus into a CPR position. A magnet is coupled to an end of the arm and configured to move about the axel between the deactivated position and the activated position. A magnetic field detector detects a magnetic field generated by the magnet when the arm is in the deactivated position. The magnetic field detector does not detect the magnet field when the arm is in the activated position. The magnetic field detector transmits an electrical current in the presence of the magnetic field.

In some embodiments of the third aspect, a controller may be provided. When the arm is in the deactivated position, the controller may receive the electrical current. When the arm is in the activated position, the controller may not receive the electrical current.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of an exemplary hospital bed in accordance with an embodiment.

FIG. 2 is a view of a quick release system for a CPR handle, in accordance with an embodiment, wherein a cover of the system is removed to show an inside of the system, and

wherein a reed switch is attached to an outside of the system.

FIG. 3 is a schematic view of the quick release system shown in FIG. 2 in a deactivated position.

FIG. 4 is a schematic view of the quick release system shown in FIG. 2 in an activated position.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

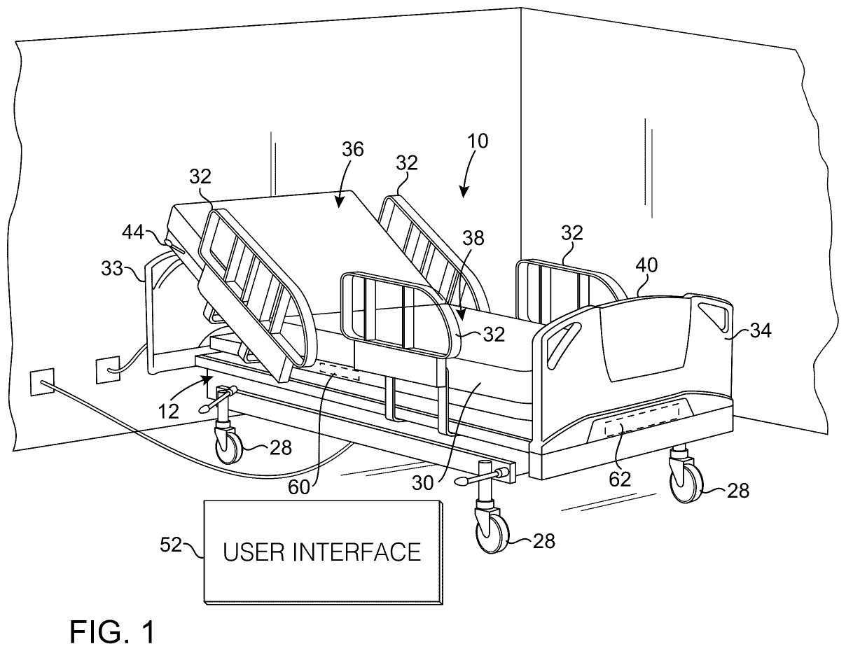

Referring to FIG. 1, a patient support apparatus is embodied as a hospital bed 10. The bed 10 includes a frame 12 that is movable between an operating position and a CPR position. The frame 12 included in the bed 10 is supported by wheels or casters 28. The bed 10 includes a mattress 30 supported by the frame 12, a number of siderails 32, a footboard 34, and a headboard 33. The bed 10 also includes multiple support sections such as a head support section 36, a midsection support section 38, and a foot support section 40. An actuator 60 of the frame 12 is adjustably operable to place the bed support sections in multiple positions relative to one another.

In an exemplary embodiment, the frame 12 is adjustable to place the bed 10 in a CPR position in which the head support section 36, the midsection support section 38, and the foot support section 40 lie substantially parallel to one another and ground 42. The patient resting on the bed 10 while the bed 10 is in the CPR position receives head support from the head support section 36, midsection support from the midsection support section 38, and leg and foot support from the foot support section 40 at substantially the same distance above ground 42.

The CPR handle 44 is coupled to the frame 12 and is used to adjust the frame 12 to release the actuator 60 and move the frame 12 toward the CPR position. In some embodiments, a CPR handle 44 is provided on both sides of the frame 12. That is, when the CPR handle 44 is activated, the actuator 60 is released so that the frame 12 of the bed 10 is moved into the CPR position. When the CPR handle 44 is activated, the head support section 36 rapidly drops to the substantially parallel position. Additionally, when the CPR handle 44 is activated, at least one motor moves the midsection support section 38 and the foot support section 40 to lie substantially parallel to one another and the ground 42. In some embodiments, in response to the CPR handle 44 being activated, the bed 10 is moved into the Trendelenburg position. In some embodiments, in response to the CPR handle 44 being activated, bladders in the mattress 30 are completely deflated to provide a hard surface for performing CPR. In some embodiments, in response to the CPR handle 44 being activated, bladders in the mattress 30 are inflated to a maximum inflation to provide a hard surface for performing CPR. In some embodiments, the maximum inflation is within a range of 20 to 55 inches of water. When the CPR handle is deactivated, the frame 12 of the bed 10 remains in a selected position. The CPR handle 44 is movable relative to the frame 12 and may be activated to move the bed 10 toward the CPR position until the bed 10 is placed in the CPR position. The CPR handle 44 may also be deactivated to allow the frame 12 to remain in the operating position. As described in more detail below, a signal is transmitted to a controller 62 of the bed 10 to indicate whether the CPR handle 44 is activated. The controller 62 is in communication with a user interface 52 that displays indicia indicating whether the CPR handle 44 is activated or deactivated. As described in more detail below, the user interface 52 indicates to a user whether the CPR handle 44 is activated or deactivated based on whether the controller 62 receives the electrical current. In some embodiments, the user interface 52 is located on the frame 12 and/or within the vicinity of a patient room. In some embodiments, the user interface 52 is a remote interface, for example, at a nurse's station or elsewhere in a healthcare facility. In some embodiments, the user interface 52 is provided on a mobile device.

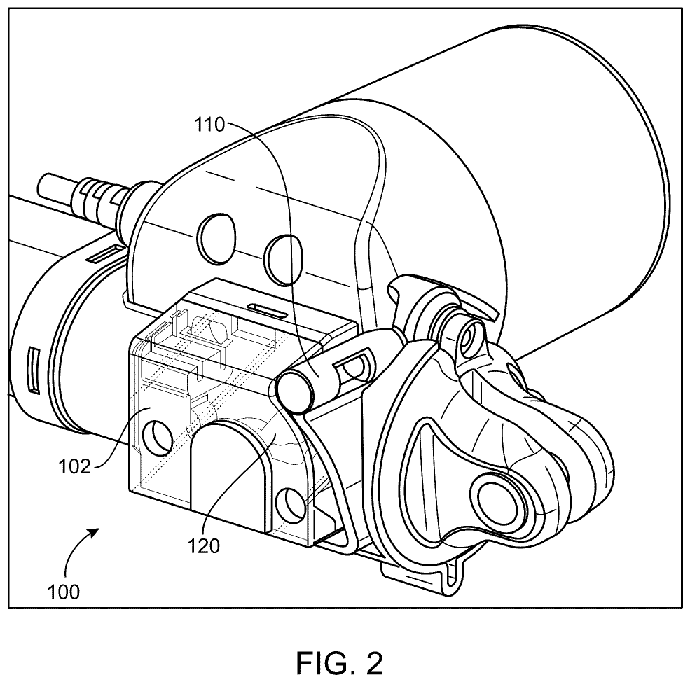

Referring now to FIG. 2, quick release system 100 for the bed 10 includes a housing 102 coupled to the patient support apparatus 10. A magnetic field detector 110 is positioned outside the housing 102. It will be appreciated that in some embodiments the magnetic field detector 110 is positioned inside the housing 102. In an exemplary embodiment, the magnetic field detector 110 is embodied as a reed switch that transmits an electrical current in the presence of a magnetic field. An arm 120 is positioned inside the housing 102. The arm 120 is coupled to the CPR handle 44 and operable to move with the CPR handle 44 between an activated position and a deactivated position. That is, when the CPR handle 44 is activated to release the actuator 60 of the frame 12, the arm 120 is moved to an activated position, and, when the CPR handle 44 is deactivated to maintain an operating position of the frame 12, the arm 120 is moved to a deactivated position.

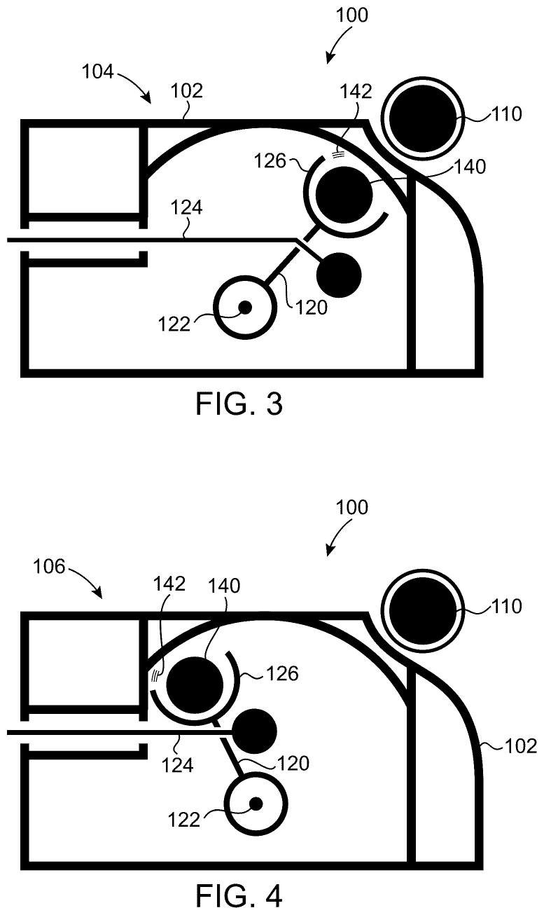

FIG. 3 illustrates the arm 120 in the deactivated position 104, and FIG. 4 illustrates the arm 120 in the activated position 106. Referring to FIGS. 3 and 4, the arm 120 is coupled to the CPR handle 44 by a CPR cable 124 that extends between the arm 120 and the CPR handle 44. The arm 120 is moveable with the CPR handle 44. In an embodiment having a CPR handle 44 on each side of the frame 12, two CPR cables 124 are provided, wherein each CPR cable 124 extends from the arm 120 to one of the CPR handles 44 . . . . The CPR cable 124 attaches to the arm 120 between an end 126 of the arm 120 and an axel 122. It will be appreciated that the CPR cable 124 is attachable to any position of the arm 120 between the end 126 and the axel 122. In some embodiments, the CPR cable 124 is attached to the end 126 of the arm 120. The arm 120 rotates about the axel 122 between the deactivated position 104 and the activated position 106. The axel 122 is coupled to the actuator 60. When in the activated position 106, the arm 120 rotates the axel 122 to release the actuator 60 so that the frame 12 of the bed 10 moves into the CPR position.

A magnet 140 is coupled to the arm 120. In the exemplary embodiment, the magnet 140 is coupled to the end 126 of the arm 120. In the exemplary embodiment, the end 126 of the arm 120 includes a concave surface that forms a cup, and the magnet 140 is held in the cup. The magnet 140 is configured to move when the arm 120 is moved between the deactivated position 104 and the activated position 106. In the exemplary embodiment, the magnet 140 rotates about the axel 122 when the arm 120 is rotated between the deactivated position 104 and the activated position 106. The magnet 140 generates a magnetic field 142 that is detectable by the magnetic field detector 110.

The magnetic field detector 110 detects the magnetic field 142, when the magnetic field 142 is within a predetermined distance to the magnet field detector 110. When the arm 120 is in the deactivated position 104, the magnet 140 is positioned proximate to the magnetic field detector 110 so that the magnetic field 142 is within the predetermined distance and detected by the magnetic field detector 110. The magnetic field detector 110 transmits an electrical current in the presence of the magnetic field 142. That is, when the arm 120 is in the deactivated position 104, the magnetic field detector 110 transmits the electrical current. Accordingly, when the CPR handle 44 is in the deactivated position 104, the arm 120 positions the magnet 140 so that the magnetic field detector 110 transmits the electrical current, which is received at the controller 62. The controller 62 causes the user interface 52 to indicate to the user that the CPR handle 44 is in the deactivated position 104 when the controller 62 receives the electrical current.

When the arm 120 is in the activated position 106, the magnet 140 is moved away from the magnetic field detector 110 so that the magnetic field 142 is not within the predetermined distance and is not detected by the magnetic field detector 110. The magnetic field detector 110 stops transmitting the electrical current when the magnetic field 142 is not detected. That is, when the arm 120 is in the activated position 106, the magnetic field detector 110 does not transmit the electrical current. Accordingly, when the CPR handle 44 is in the activated position 106, the arm 120 positions the magnet 140 so that the magnetic field detector 110 does not transmit the electrical current. The controller 62 causes the user interface 52 to indicates to the user that the CPR handle 44 is in the activated position 106 when the controller 62 does not receive the electrical current.

In some embodiments, when the CPR handle 44 is in the activated position 106, the controller 62 causes at least one motor to move the midsection support section 38 and the foot support section 40 to lie substantially parallel to one another and the ground 42, in response to the controller 62 not receiving the electrical current. In some embodiments, when the CPR handle 44 is in the activated position 106, the controller 62 causes the bed 10 to be moved into the Trendelenburg position, in response to the controller 62 not receiving the electrical current. In some embodiments, when the CPR handle 44 is in the activated position 106, the controller 62 causes bladders in the mattress 30 to be completely deflated to provide a hard surface for performing CPR, in response to the controller 62 not receiving the electrical current. In some embodiments, when the CPR handle 44 is in the activated position 106, the controller 62 causes bladders in the mattress 30 to be inflated to a maximum inflation to provide a hard surface for performing CPR, in response to the controller 62 not receiving the electrical current.

The disclosed embodiments ensure an optimum reliability of the actuator without any change to the design of the actuator parts. The quick release system is linked to critical functions and requires a maximum level of reliability. The disclosed embodiments, provide a cost effective solution to detection of the quick release mechanism. The disclosed embodiments also allow a live detection of the clutching system without any other factors in the quick release mechanism, for example the cables or the handles.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A patient support apparatus comprising:
a frame having an actuator that moves the frame to various positions,
a handle that is moveable between a deactivated position and an activated position, wherein, in the activated position, the handle releases the actuator of the frame to move the frame to a CPR position,
an arm coupled to the handle and moveable with the handle, wherein, in the activated position, the arm releases the actuator,
a magnet coupled to the arm, and
a magnetic field detector to detect the magnet when the handle is in the deactivated position, wherein the reed switch does not detect the magnet when the handle is in the activated position.

2. The patient support apparatus of claim 1, further comprising a housing, wherein the arm and the magnet are positioned inside the housing, wherein the magnetic field detector is positioned outside the housing.

3. The patient support apparatus of claim 1, wherein the magnet generates a magnetic field that is detectable by the magnetic field detector, and wherein the magnetic field detector transmits an electrical current in the presence of the magnetic field.

4. The patient support apparatus of claim 3, further comprising a controller, wherein, when the handle is in the deactivated position, the controller receives the electrical current, and, when the handle is in the activated position, the controller does not receive the electrical current.

5. The patient support apparatus of claim 4, further comprising a user interface that indicates to a user whether the handle is in the activated position or the deactivated position based on whether the controller receives the electrical current.

6. The patient support apparatus of claim 5, wherein the user interface is at least one of a mobile device and a remote device.

7. The patient support apparatus of claim 1, wherein:
the arm rotates about an axel, and
the magnet is positioned on an end of the arm so that the magnet rotates about the axel.

8. The patient support apparatus of claim 1, wherein a cable attaches the arm to the handle.

9. The patient support apparatus of claim 1, wherein, in response to the handle being moved to the activated position, at least one motor moves the frame to lie substantially parallel to the ground.

10. The patient support apparatus of claim 1, wherein, in response to the handle being moved to the activated position, the frame is moved into a Trendelenburg position.

11. The patient support apparatus of claim 1, wherein, in response to the handle being moved to the activated position, a mattress positioned on the frame is at least one of deflated or inflated.

12. A quick release system for a patient support apparatus comprising:
an arm that is moveable between a deactivated position and an activated position, wherein, in the activated position, the arm releases an actuator so that a frame of the patient support apparatus moves to a CPR position,
a magnet coupled to the arm, and
a magnetic field detector to detect the magnet when the arm is in the deactivated position, wherein the magnetic field detector does not detect the magnet when the arm is in the activated position.

13. The quick release system of claim 12, further comprising a housing, wherein the arm and the magnet are positioned inside the housing, wherein the magnetic field detector is positioned outside the housing.

14. The quick release system of claim 12, wherein the magnet generates a magnetic field that is detectable by the magnetic field detector, and wherein the magnetic field detector transmits an electrical current in the presence of the magnetic field.

15. The quick release system of claim 14, further comprising a controller, wherein, when the arm is in the deactivated position, the controller receives the electrical current, and, when the arm is in the activated position, the controller does not receive the electrical current.

16. The quick release system of claim 15, further comprising a user interface that indicates to a user whether the arm is in the activated position or the deactivated position based on whether the controller receives the electrical current.

17. The quick release system of claim 16, wherein the user interface is at least one of a mobile device and a remote device.

18. The quick release system of claim 12, wherein:
the arm rotates about an axel, and
the magnet is positioned on an end of the arm so that the magnet rotates about the axel.

19. The quick release system of claim 18, wherein the axel couples to the actuator.

20. A quick release system for a patient support apparatus comprising:
a housing coupled to the patient support apparatus,
an arm positioned in the housing, wherein the arm is moveable about an axel between a deactivated position and an activated position, wherein, in the activated position, the arm releases a frame of the patient support apparatus into a CPR position,
a magnet coupled to an end of the arm and configured to move about the axel between the deactivated position and the activated position,
a magnetic field detector to detect a magnetic field generated by the magnet when the arm is in the deactivated position, wherein the magnetic field detector does not detect the magnet field when the arm is in the activated position, wherein the magnetic field detector transmits an electrical current in the presence of the magnetic field, and
a controller, wherein, when the arm is in the deactivated position, the controller receives the electrical current, and, when the arm is in the activated position, the controller does not receive the electrical current.
